(19) United States
(12) Patent Application Publication
(10) Pub. No.: US 2024/0370523 A1
(43) Pub. Date: Nov. 7, 2024

(54) METHOD AND APPARATUS FOR PERFORMING DEPTHWISE CONVOLUTION OPERATION BASED ON A SYSTOLIC ARRAY

(71) Applicant: Research & Business Foundation Sungkyunkwan University, Suwon-si (KR)

(72) Inventors: Hyungmin CHO, Seoul (KR); Mingeon PARK, Suwon-si (KR); Seokjin HWANG, Seoul (KR)

(73) Assignee: Research & Business Foundation Sungkyunkwan University, Suwon-si (KR)

(21) Appl. No.: 18/652,352

(22) Filed: May 1, 2024

(30) Foreign Application Priority Data
May 2, 2023 (KR) 10-2023-0057115

(51) Int. Cl. G06F 17/15

(52) U.S. Cl. CPC G06F 17/153

(57) ABSTRACT

The present disclosure relates to a method and apparatus for performing depthwise convolution operation based on a systolic array, and a method of operating a systolic array including a plurality of processing element chains according to an embodiment of the present disclosure may include preloading a weight value to at least one of a plurality of first processing elements included in a first processing element chain, one of the plurality of processing element chains, through a first weight data link that is a column input link, providing a first input frame to a first processing element disposed at a tail portion of the first processing element chain among the plurality of first processing elements through a first input data link that is a row input link, obtaining a first output value by continuously performing operations from the first processing element disposed at the tail portion to a first processing element disposed at a head portion of the first processing element chain, based on a weight value preloaded on the first input frame and each of the plurality of first processing elements, through the first input data link, and obtaining a first cumulative sum value by continuously performing operations from the first processing element disposed at the head portion to the first processing element disposed at the tail portion, based on a weight value preloaded on the first output value and at least one of the plurality of first processing elements, through the first cumulative sum link, which is the row input link.

### CROSS-REFERENCE TO RELATED APPLICATION

This application claims priority to and the benefit of Korean Patent Application No. 10-2023-0057115 filed in the Korean Intellectual Property Office on May 2, 2023, the entire contents of which are incorporated herein by reference.

### BACKGROUND OF THE INVENTION

### Field of the Invention

The present disclosure relates to a method and apparatus for performing depthwise convolution on a systolic array, and particularly to a method and apparatus for performing depthwise convolution operation based on a systolic array.

### Description of the Related Art

In general, systolic arrays are optimized for general two-dimensional matrix multiplication (GEMM) operations. When calculating the general convolution layer of a deep learning model, the systolic array performs operations by converting the convolution layer into a two-dimensional matrix multiplication operation and then operating it. However, in the case of depthwise convolution, when converted to 2-dimensional matrix multiplication, the converted matrix contains many parts that are empty as zero. Excluding these zero values, among the systolic arrays composed of each S processing elements (total SXS) horizontally and vertically, only S processing elements participate in actual calculations. As a result, problems may occur in which the utilization of processing elements is greatly reduced when performing depthwise convolution operation, and in which the processing time of the entire deep learning model also becomes slower.

### SUMMARY OF THE INVENTION

The purpose of the present disclosure is to solve the above problems, and to provide a method and apparatus for performing depthwise convolution operations based on a systolic array for effectively accelerating depthwise convolution operations in a systolic array.

A method of operating a systolic array including a plurality of processing element chains according to an embodiment of the present disclosure may comprise preloading a weight value to at least one of a plurality of first processing elements included in a first processing element chain, one of the plurality of processing element chains, through a first weight data link that is a column input link, providing a first input frame to a first processing element disposed at a tail portion of the first processing element chain among the plurality of first processing elements through a first input data link that is a row input link, obtaining a first output value by continuously performing operations from the first processing element disposed at the tail portion to a first processing element disposed at a head portion of the first processing element chain, based on a weight value preloaded on the first input frame and each of the plurality of first processing elements, through the first input data link, and obtaining a first cumulative sum value by continuously performing operations from the first processing element disposed at the head portion to the first processing element disposed at the tail portion, based on a weight value preloaded on the first output value and at least one of the plurality of first processing elements, through the first cumulative sum link, which is the row input link.

Each of the plurality of processing elements included in the first processing element chain may include one of an active processing element or a non-active processing element, and the preloading a weight value to at least one of a plurality of processing elements included in the first processing element chain, one of the plurality of processing element chains, through the weight data link that is the column input link, may load a weight value to processing elements including the active processing element among the plurality of processing elements.

In the first processing element chain, a plurality of the active processing elements and one non-active processing element may be arranged in series.

The weight values may be loaded based on column-major order.

The method may further comprise preloading a weight value to at least one of a plurality of second processing elements included in a second processing element chain, one of the plurality of processing element chains, through a second weight data link that is a column input link, providing a second input frame to a second processing element disposed at a tail portion of the second processing element chain among the plurality of second processing elements through a second input data link that is a row input link, obtaining a second output value by continuously performing operations from the second processing element disposed at the tail portion of the second processing elements to a second processing element disposed at a head portion of the second processing element chain, based on a weight value preloaded on the second input frame and each of the plurality of second processing elements, through the second input data link, and obtaining a second cumulative sum value by continuously performing operations from the second processing element disposed at the head portion to the second processing element disposed at the tail portion, based on a weight value preloaded on the second output value and at least one of the plurality of second processing elements, through the second cumulative sum link, which is the row input link.

The providing a second input frame to a second processing element disposed at a tail portion of the second processing element chain among the plurality of processing elements through a second input data link that is a row input link may include, providing a second input frame to the second processing element disposed in the tail portion based on an (M+1) cycle, the M may be a time required for one of the first processing elements to perform an operation based on the preloaded weight and the first output value, and the cycle may be a difference between a time provided to the first processing element in which the first input frame is disposed in the tail portion and a time to obtain the first cumulative sum.

In the step of obtaining the second output value, at least one of the second processing elements may not perform the operation based on the second input frame and the preloaded weight value.

In the step of obtaining the second cumulative sum value, at least one of the second processing elements may not perform the operation based on the second output value and the preloaded weight value.

According to the present disclosure, a structure for effectively accelerating depthwise convolution in a systolic array is proposed to be possible to reuse input in two directions without hindering the area and power efficiency of the systolic array optimized for matrix operations and general convolution operations, which can increase the speed of depthwise convolution operations.

According to the present disclosure, it is possible to improve the operation performance of deep learning models by effectively accelerating deep learning models using depthwise convolution such as MobileNet, EfficientNet, and MobileViT through a systolic array.

### BRIEF DESCRIPTION OF THE DRAWINGS

The accompanying drawings, which are included to further understand the present disclosure, included in the present disclosure and constitute a part of the present application, represent embodiments of the present disclosure along with detailed descriptions that illustrate the principles of the present disclosure.

FIG. 1 is a conceptual diagram of a systolic array according to the prior art of the present disclosure.

FIG. 2 is a conceptual diagram of a systolic array according to an embodiment of the present disclosure.

FIGS. 3 and 4 are conceptual diagrams for explaining an operation method of a processing element according to an embodiment of the present disclosure.

FIG. 5 is a conceptual diagram for explaining an operation method of a processing element according to another embodiment of the present disclosure.

FIG. 6 is a conceptual diagram for explaining an operation method of a processing element according to still another embodiment of the present disclosure.

FIGS. 7 and 8 are conceptual diagrams of input frames according to an embodiment of the present disclosure.

FIG. 9 is a flowchart of a method of operating a systolic array according to an embodiment of the present disclosure.

FIGS. 10 and 11 are conceptual diagrams for explaining an effect of a systolic array operation method according to an embodiment of the present disclosure.

### DETAILED DESCRIPTION OF THE EMBODIMENTS

Hereinafter, embodiments disclosed in the present disclosure will be described in detail with reference to the accompanying drawings, but the same or similar elements are denoted by the same reference numerals regardless of the reference numerals, and redundant descriptions thereof will be omitted. The suffixes “module” and “unit” of elements used in the following description are given or used interchangeably in consideration of only the ease of writing the specification, and do not themselves have a distinct meanings or roles. In addition, in describing the embodiments disclosed in the present disclosure, when it is determined that a detailed description of related known technologies may obscure the subject matter of the embodiments disclosed in the present disclosure, the detailed description thereof will be omitted. In addition, the accompanying drawings are for easy understanding of the embodiments disclosed in the present disclosure, the technical spirit disclosed in the present disclosure is not limited by the accompanying drawings, and are to be understood as including all modifications, equivalents, and alternatives included in the spirit and scope of the present disclosure.

While terms, such as “first”, “second”, etc., may be used to describe various elements, the elements are not limited by the above terms. The above terms are used only for the purpose of distinguishing one element from another element.

When an element is referred to as being “electrically coupled” or “connected” to another element, it should be understood that other element may exist in the middle although the element may be directly electrically coupled or connected to the other element. On the other hand, when an element is referred to as being “directly electrically coupled” or “directly connected” to another element, it should be understood that there is no other element in the middle. Expressions in the singular include plural expressions unless the context clearly indicates otherwise.

In the present disclosure, it should be understood that terms such as “comprises” or “have” are intended to designate the presence of features, numbers, steps, operations, elements, parts, or combinations thereof described in the specification, but do not preclude the possibility of the presence or addition of one or more other features, numbers, steps, operations, elements, parts, or combinations thereof.

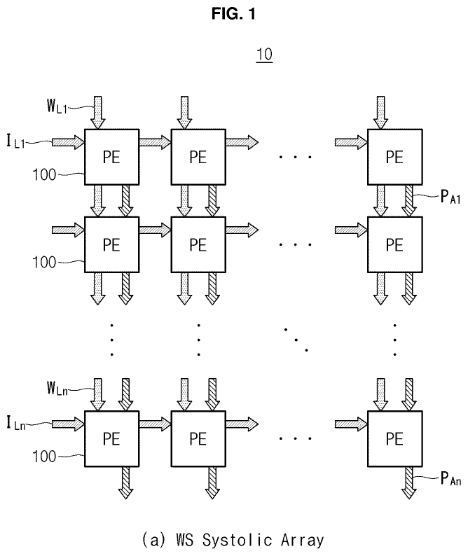

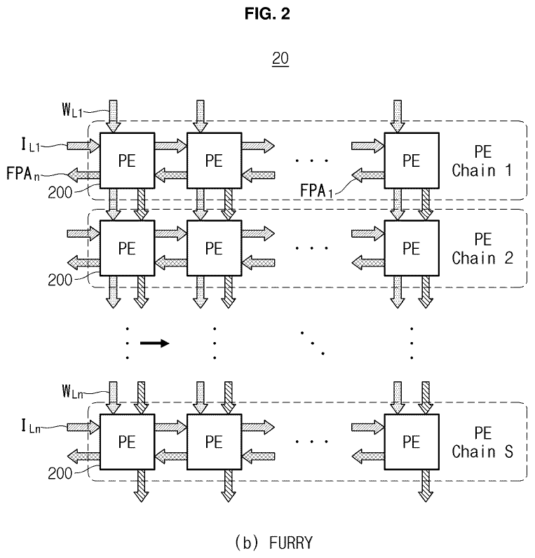

FIG. 1 is a conceptual diagram of a systolic array according to the prior art of the present disclosure. FIG. 2 is a conceptual diagram of a systolic array according to an embodiment of the present disclosure.

Referring to FIG. 1, the entire structure of the systolic array 10 of the prior art may include processing elements (operation element; processing element, hereinafter described as processing element, 100) arranged in a two-dimensional array.

Each processing element 100 may have three types of data links: an input value data link (IL1 to ILn), a weight data link (WL1 to WLn), and a first partial sum data link (PA1 to PAn). In the case of the systolic array of the prior art, the input value data link (IL1 to ILn) may be a row input link, and the weight data link (WL1 to WLn) and the first partial sum data link (PA1 to PAn) may be a column input link.

Referring to FIG. 2, the systolic array 20 according to an embodiment of the present disclosure may include processing elements 200 arranged in a two-dimensional array. Each processing element 200 may have three types of data links: an input value data link (IL1 to ILn), a weight data link (WL1 to WLn), and a second partial sum data link (FPA1 to FPAn). The input value data link (IL1 to ILn) and the second partial sum data links (FPA1 to FPAn) may be referred to as row input links, and the weight data link (WL1 to WLn) may be referred to as column input links.

That is, in the systolic array 10 according to the prior art, the directions of the input value data link (IL1 to ILn) and the first partial sum data link (PA1 to PAn) are orthogonal to each other, but in the systolic array 20 according to an embodiment of the present disclosure, the directions of the input value data link (IL1 to ILn) and the second partial sum data link (FPA1 to FPAn) are in the same direction, which is the difference.

Meanwhile, each of the processing elements 200 is assigned to each dimension of the depthwise convolution. For example, if the systolic array 20 includes S processing elements 200 horizontally and vertically, the number of processing elements 200 may be SXS. The processing elements 200 included in the same row may form a processing element chain. In the case of FIG. 2, the systolic array 20 may include S processing element chains (PE chain 1 to PE chain s). Wherein PE stands for processing element. When the depthwise convolution layer includes C channels, the systolic array 20 can perform C/S operations. Each processing element 200 can perform operations in the following manner.

In the depthwise convolution, there are Iₕ×I_{w} input values for each channel, which are called input maps. In the present disclosure, among the input maps, the area that is currently being inserted into the systolic array is referred to as an input frame. The size of the input frame will be described later.

Among the processing element chains (e.g. (PE chain 1 to PE chain s) in FIG. 2), a side where the input value is input is called Tail, and the opposite end is called Head. Input values are input through the tail of the processing element chain, one per (M+1) cycle. Here, M may be the time required for the partial sum obtained by multiplying the input value of each processing element and the weight value to be accumulated to the previous partial sum.

First, the description will be based on the case where M is 0, and the case where M is 1 or more will be described later. The input values of the input frame are inserted into the processing element chain in column-major order, and in one column, all input values corresponding to the height of the input frame are input, and then the input values of the next column are input sequentially.

Like the systolic array according to the prior art (e.g. systolic array 10 in FIG. 1), in the case of the systolic array according to an embodiment of the present disclosure (e.g. systolic array 20 in FIG. 2), each processing element (e.g. operation element 200 of FIG. 2) is preloaded with weight values before performing the convolution operation.

Among the processing elements included in the processing element chain, KXK processing elements are pre-loaded with actual weight values, where KXK corresponds to the size of the convolution filter. Except for this, the remaining processing elements are loaded with zero, not the actual weight value. A processing element loaded with a weight value is called an active processing element, and an processing element loaded with zero rather than a weight value is called a non-active processing element. Starting from the head of the processing element chain, weight values are also loaded in column-major order, and the K weight values corresponding to one filter column are followed by several non-active processing elements. The number of processing elements determines the degree of reuse of input values. The number of non-active processing elements will be described later.

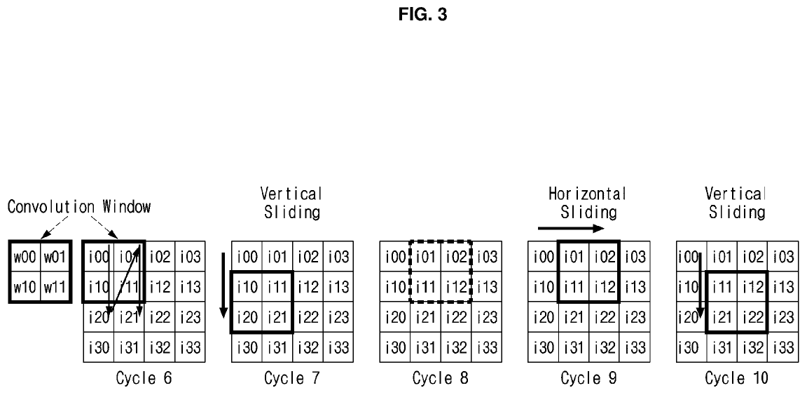

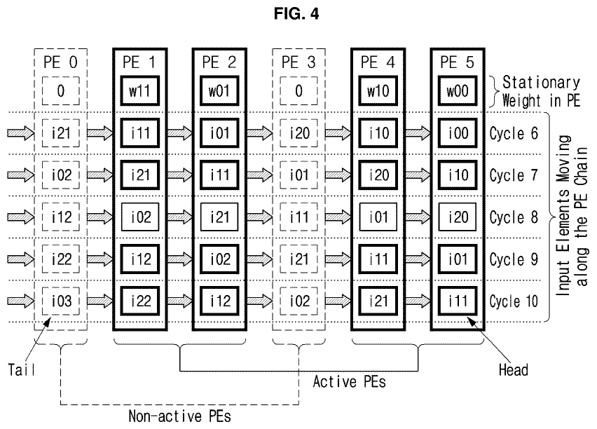

FIGS. 3 and 4 are conceptual diagrams for explaining an operation method of a processing element according to an embodiment of the present disclosure.

FIG. 3 shows a location of an input frame inserted into a processing element chain for each cycle on an input map (the area of colored input values corresponds to the input frame) FIG. 4 is a diagram showing how input values corresponding to input frames for each cycle in FIG. 3 are inserted into a one-dimensional processing element chain. In this example, a convolution filter of size 2×2 is used, and the size of the input frame is configured to 3×2. As shown in FIG. 4, the processing element chain corresponding to such an input frame is composed of a repetitive structure in which K (i.e. 2) active processing elements are followed by one non-active processing element from the head to the tail.

In cycle 6 of FIG. 3, input values corresponding to i00 to i21 correspond to the input frame. As shown in the same cycle in FIG. 3, input values are input to the input element chain in row priority order as described above (i00->i10->i20->i01->i11->i21). In this case, the input values i00, i10, i01, and i11 included in the input frame correspond to the convolution window for calculating the first output value, o00. In addition, the PE where these input values are located in the input element chain of FIG. 3 is loaded with weight values corresponding to each input value, and in each PE, the output value can be obtained by multiplying the weight value and the input value and accumulating them.

In the next cycle, new input values enter the input frame and processing element chain, and the oldest input value leaves the input frame and input element chain. Since all three input values for the second column were input in the previous cycle, cycle 7 moves to the next column and input i02 is entered as a new input value, and i00, the oldest input value, is excluded from the input frame and input element chain. In cycle 7, the input frame is no longer a rectangular area. At this time, i10, i20, i11, and i21 over the 2×2 area from the i10 input value located at the head of the input element chain are the convolution window corresponding to the second output value, and in FIG. 4, it can be seen that the corresponding input values are matched with weight values corresponding to the convolution window. That is, in this cycle, by moving the input frame range, the same effect can be obtained as if the convolution window was moved one step vertically. At this time, the input values i10 and i11 are reused once again following the previous output value operation.

If the vertical movement of the convolution window continues, each input value can be reused up to K times. However, in this example, because a small input frame size was used, only one step in the vertical direction is possible, however, if the height of the input frame is set large, the convolution window can be moved vertically several times.

In the subsequent cycle, cycle 8, the correct convolution window is not formed from the processing element chain head, and cycle 8 becomes a skip cycle that passes without generating the correct output value.

Afterwards, in cycle 9, the processing element chain head is again positioned at the top of one row, and correct convolution window formation is possible. The convolution window generated at this time is equivalent to moving the window used in previous cycles by one step in the horizontal direction, and the overlapping input values i01 and i11 are reused again. If the convolution window continues to move horizontally, each input value can be reused up to KXK times, including reuse due to horizontal movement and reuse due to vertical movement. This corresponds to the maximum number that one input value can be reused in depthwise convolution by.

The number of moves possible in the vertical direction is determined by the height of the input frame, while the number of moves possible in the horizontal direction is independent of the size of the input frame. Depending on the size of the input map or output map, horizontal movement of the convolution window can continue until there is no more room left to move.

FIGS. 3 and 4 assume that the time required for accumulating partial sums M is 0. However, in the case of a systolic array, a delay time of 1 cycle or more is required for each processing element stage to accumulate partial sums. In this case, as shown in FIGS. 3 and 4, it may not be applicable a method in which the input value corresponding to one output value in one cycle arrives at the active input element simultaneously.

To solve this, when M is 1 or more, it can be adjusted the frequency with which the input value is supplied to the input chain element. Specifically, each input value is input one at a time every M+1 cycle. In this case, partial sum accumulation is possible even if a delay of M cycles is added at each step through the partial sum data link configured in the opposite direction of the input data link. This is explained in detail as follows.

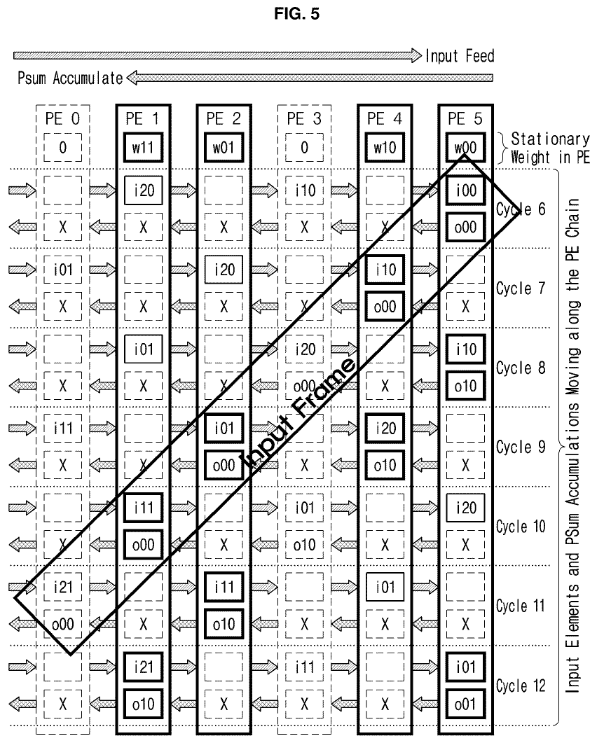

FIG. 5 is a conceptual diagram for explaining an operation method of a processing element according to another embodiment of the present disclosure.

FIG. 5 shows a case where M is 1 and one input value is input every two cycles. When the first input value reaches the head (Cycle 6) partial sum accumulation for the output values can start, when the partial sum value moves through the partial sum data link, for each active element stage, the required input values and preloaded weight values may be encountered in the active processing element, and when the tail of the active element chain is reached, accumulation is completed and the output value can be obtained.

As shown in FIG. 5, if one input value is input per M+1 cycle, correct calculation can be made even when M is 1 or more, but a gap of M cycles is created between each input value, and the computational throughput is correspondingly reduced. Instead, such throughput degradation can be prevented by overlapping M+1 operations simultaneously.

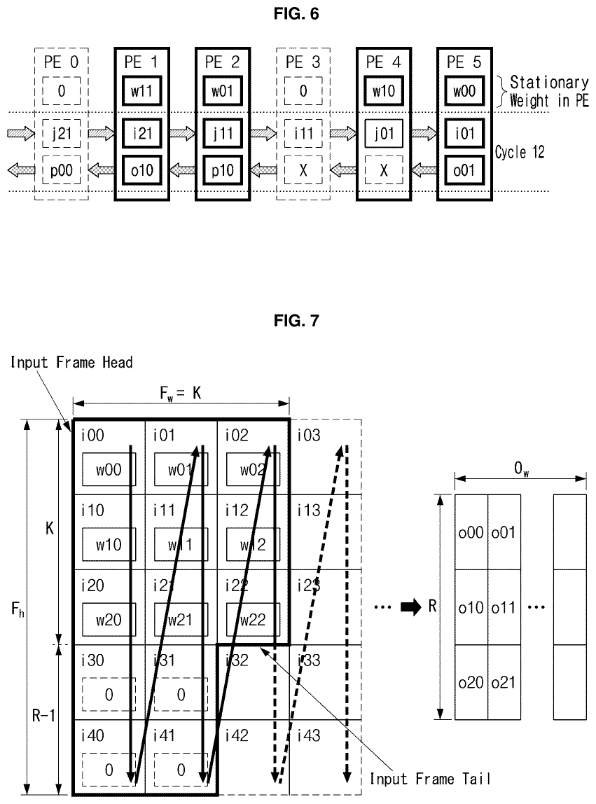

FIG. 6 is a conceptual diagram for explaining an operation method of a processing element according to still another embodiment of the present disclosure.

FIG. 6 shows a case where two operations are overlapped when M is 1. For the second operation added, the input and output values are indicated by the symbols j and p, respectively. It can be seen that output value operation is possible at a higher frequency than the same cycle 12 in FIG. 5.

FIGS. 7 and 8 are conceptual diagrams of input frames according to an embodiment of the present disclosure.

Referring to FIGS. 7 and 8, the height and width of the input frame are Fh and Fw, respectively, and R, the number of vertical movements of the convolution window, can be determined based on the height Fh. R can be the number of output rows operated together at one time. The larger R is, the more input values are reused up to K times, so it is advantageous to have a large R value. Since R is determined by Fh−K+1, Fh should be increased as much as possible. On the other hand, in the case of Fw, there is no direct effect on the degree of input reuse. However, since one convolution window must be completely included in the input frame, Fw is configured to K. Additionally, as shown in FIG. 8, input frames must be included in a row in one input element chain. Each of the processing elements shown in FIG. 8 is expressed as a weight value loaded into the corresponding PE. For example, in FIG. 8, a square box written w22 indicates a processing element loaded with a w22 weight value. If the length of the processing element chain is L, then L=FhXFw−(R−1). The reason for excluding R−1 at this time is that the last non-active processing elements do not need to be included in the processing element chain. This processing element chain must be shorter than S, which is the width of the systolic array. That is, since LES, Fh can be determined as in Equation 1 below.

$${F}_{h} = ⌊ \frac{S + K}{K - 1} ⌋ \qquad [ Equation 1 ]$$

In Equation 1, for example, if the horizontal axis length of the systolic array is 16 (including 16 processing elements) and the convolution filter size used is 3×3, Fh is 5 and R is 3. That is, in this configuration, repeated vertical and horizontal input is reused through the input frame, and when moving the convolution window, output values corresponding to three rows of the output map can be operated at once. According to the present disclosure, when operating depthwise convolution, it is possible to improve the calculation speed by up to KXK times compared to a matrix product-based depthwise convolution operation.

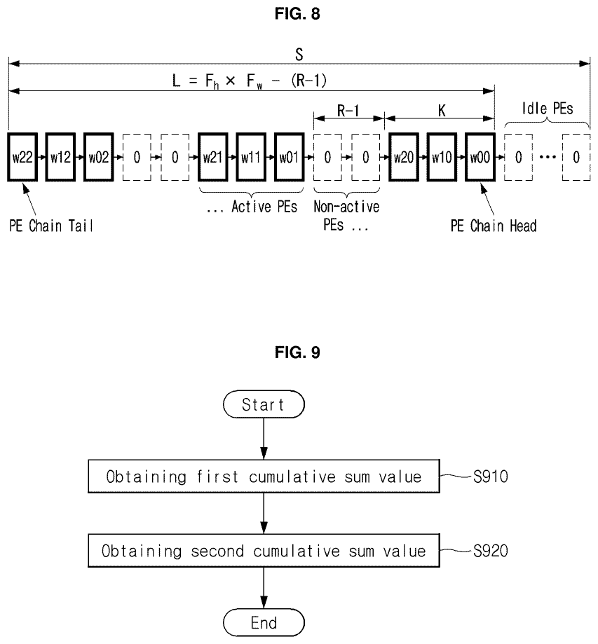

FIG. 9 is a flowchart of a method of operating a systolic array according to an embodiment of the present disclosure.

Referring to FIG. 9, a systolic array may obtain a first cumulative sum value (S910). The step S910 may include preloading a weight value to at least one of a plurality of first processing elements included in a first processing element chain, one of the plurality of processing element chains, through a first weight data link that is a column input link, providing a first input frame to a first processing element disposed at a tail portion of the first processing element chain among the plurality of first processing elements through a first input data link that is a row input link, obtaining a first output value by continuously performing operations from the first processing element disposed at the tail portion to a first processing element disposed at a head portion of the first processing element chain, based on a weight value preloaded on the first input frame and each of the plurality of first processing elements, through the first input data link, and obtaining a first cumulative sum value by continuously performing operations from the first processing element disposed at the head portion to the first processing element disposed at the tail portion, based on a weight value preloaded on the first output value and at least one of the plurality of first processing elements, through the first cumulative sum link, which is the row input link.

Here, each of the plurality of processing elements included in the first processing element chain includes one of an active processing element or a non-active processing element, and the preloading a weight value to at least one of a plurality of processing elements included in the first processing element chain, one of the plurality of processing element chains, through the weight data link that is the column input link, may load a weight value to processing elements including the active processing element among the plurality of processing elements.

Here, in the first processing element chain, a plurality of the active processing elements and one non-active processing element may be arranged in series.

The systolic array may obtain a second cumulative sum value (S920). Here, the method may include preloading a weight value to at least one of a plurality of second processing elements included in a second processing element chain, one of the plurality of processing element chains, through a second weight data link that is a column input link, providing a second input frame to a second processing element disposed at a tail portion of the second processing element chain among the plurality of second processing elements through a second input data link that is a row input link, obtaining a second output value by continuously performing operations from the second processing element disposed at the tail portion of the second processing elements to a second processing element disposed at a head portion of the second processing element chain, based on a weight value preloaded on the second input frame and each of the plurality of second processing elements, through the second input data link, and obtaining a second cumulative sum value by continuously performing operations from the second processing element disposed at the head portion to the second processing element disposed at the tail portion, based on a weight value preloaded on the second output value and at least one of the plurality of second processing elements, through the second cumulative sum link, which is the row input link.

Here, the providing a second input frame to a second processing element disposed at a tail portion of the second processing element chain among the plurality of processing elements through a second input data link that is a row input link includes, providing a second input frame to the second processing element disposed in the tail portion based on an (M+1) cycle, the M may be a time required for one of the first processing elements to perform an operation based on the preloaded weight and the first output value, and here, the cycle may be a difference between a time provided to the first processing element in which the first input frame is disposed in the tail portion and a time to obtain the first cumulative sum.

In the step of obtaining the second output value, at least one of the second processing elements may not perform the operation based on the second input frame and the preloaded weight value.

In the step of obtaining the second cumulative sum value, at least one of the second processing elements may not perform the operation based on the second output value and the preloaded weight value.

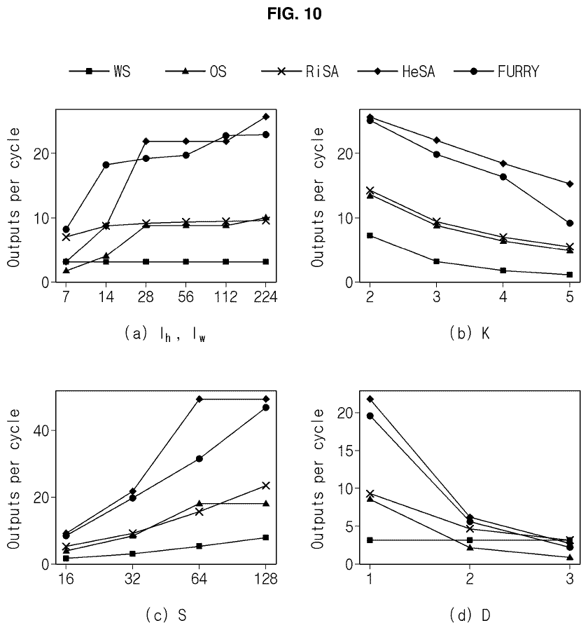

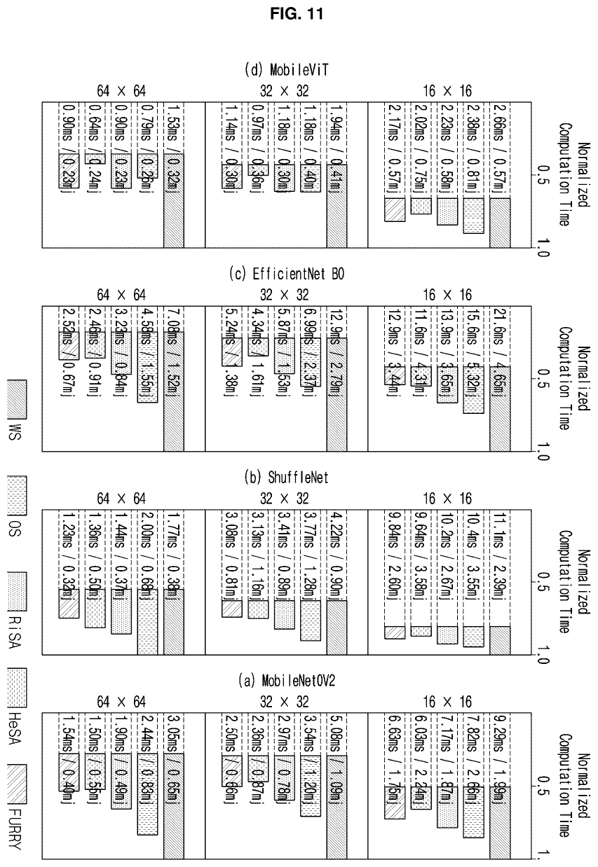

FIGS. 10 and 11 are conceptual diagrams for explaining an effect of a systolic array operation method according to an embodiment of the present disclosure.

In FIGS. 10 and 11, WS may perform depthwise convolution operation using a matrix multiplication method in an existing weight stationary systolic array. OS may perform depthwise convolution operation by applying horizontal input reuse in the existing output stationary systolic array. RiSA may perform operations based on existing data flow methods that enable horizontal one-way input reuse in the WS systolic array. HeSA may perform operations based on existing data flow methods that enable two-way input reuse in the OS systolic array. FURRY may be performing an operation according to an embodiment of the present disclosure.

FIG. 10 displays the number of output values calculated per cycle in a systolic array of size S×S. In FIG. 10, the throughput for each data flow is compared by modifying one value for each graph based on preconfigured values. The preconfigured values may be input map size (Ih, Iw): 56, filter size (K): 3, input stride (D): 1, number of channels (C): 144, and systolic array size(S): 32.

Referring to FIG. 10, it can be seen that the existing HeSA method and the method of the present disclosure are similar in terms of throughput per unit time. However, the HeSA method is based on the OS-type systolic array, which has larger area and power usage overhead than the WS method, so the overhead is inherently larger than the method of the present disclosure. For example, the overhead can be expressed as Table 1 below.

TABLE 1

| | WS | OS | RiSA | HeSA | FURRY |
|---|---|---|---|---|---|
| 16 × 16 | 1.21 | 2.24(86.1%) | 1.35 (12.2%) | 2.43 (101%) | 1.35 (12.2%) |
| 32 × 32 | 2.77 | 7.07 (155%) | 3.18 (14.6%) | 7.84 (183%) | 3.20 (15.3%) |
| 64 × 64 | 9.17 | 25.37 (177%) | 10.27 (12.1%) | 28.57 (212%) | 10.49 (14.4%) |

Table 1 is a table comparing the areas of semiconductor logic circuits when the five methods of FIGS. 10 and 11 are implemented through a systolic array. The unit is mm², and the degree of area increase compared to the WS method is also indicated. The area overhead of OS and HeSA based on the systolic array of the OS method is very high, while the area overhead of the present disclosure based on the systolic array of the WS method is relatively low, so it can be confirmed that it is 15.3% or less compared to the basic WS.

FIG. 11 shows performance comparison experimental values applying the method of the present disclosure to the inference calculation process of an actual deep learning model. The graph displays other layers in white in addition to the depthwise convolution included in the deep learning model. In this part, the processing speed is not affected by an acceleration method of the depthwise convolution operation. However, when the systolic array is modified to support the depthwise convolution, the added area and power overhead also affect other layer operations.

By applying the method of the present disclosure across evaluated MobileNet-V2, ShuffleNet, EfficientNet B0, and MobileViT, the depthwise convolution operation performance is increased by 2.9 times, 3.7 times, and 3.1 times on 16×16, 32×32, and 64×64 PE arrays, respectively. Based on the overall model operation time, the 32×32 PE array is reduced by 51%, 27%, 60%, and 41% for each model. In terms of power consumption, it showed an average of 22% lower power consumption than HeSA, which showed a similar reduction in time.

Most of the terms used in the present disclosure are selected from common ones widely used in the field, but some terms are arbitrarily selected by the applicant and their meanings are described in detail in the following description as necessary. Accordingly, the present disclosure should be understood based on the intended meaning of the terms and not the mere names or meanings of the terms.

It is obvious to those skilled in the art that the present disclosure can be embodied in other specific forms without departing from the essential features of the present disclosure. Accordingly, the above detailed description should not be construed as restrictive in all respects and should be considered illustrative. The scope of the present disclosure should be determined by reasonable interpretation of the appended claims, and all changes within the equivalent scope of the present disclosure are included in the scope of the present disclosure.

What is claimed is:

1. A method of operating a systolic array including a plurality of processing element chains, comprising:
preloading a weight value to at least one of a plurality of first processing elements included in a first processing element chain, one of the plurality of processing element chains, through a first weight data link that is a column input link;
providing a first input frame to a first processing element disposed at a tail portion of the first processing element chain among the plurality of first processing elements through a first input data link that is a row input link;
obtaining a first output value by continuously performing operations from the first processing element disposed at the tail portion to a first processing element disposed at a head portion of the first processing element chain, based on a weight value preloaded on the first input frame and each of the plurality of first processing elements, through the first input data link; and
obtaining a first cumulative sum value by continuously performing operations from the first processing element disposed at the head portion to the first processing element disposed at the tail portion, based on a weight value preloaded on the first output value and at least one of the plurality of first processing elements, through the first cumulative sum link, which is the row input link.

2. The method of claim 1, wherein each of the plurality of processing elements included in the first processing element chain includes one of an active processing element or a non-active processing element, and
wherein the preloading a weight value to at least one of a plurality of processing elements included in the first processing element chain, one of the plurality of processing element chains, through the weight data link that is the column input link, loads a weight value to processing elements including the active processing element among the plurality of processing elements.

3. The method of claim 2, wherein in the first processing element chain, a plurality of the active processing elements and one non-active processing element are arranged in series.

4. The method of claim 1, wherein the weight values are loaded based on column-major order.

5. The method of claim 1, further comprising:
preloading a weight value to at least one of a plurality of second processing elements included in a second processing element chain, one of the plurality of processing element chains, through a second weight data link that is a column input link;
providing a second input frame to a second processing element disposed at a tail portion of the second processing element chain among the plurality of second processing elements through a second input data link that is a row input link;
obtaining a second output value by continuously performing operations from the second processing element disposed at the tail portion of the second processing elements to a second processing element disposed at a head portion of the second processing element chain, based on a weight value preloaded on the second input frame and each of the plurality of second processing elements, through the second input data link; and
obtaining a second cumulative sum value by continuously performing operations from the second processing element disposed at the head portion to the second processing element disposed at the tail portion, based on a weight value preloaded on the second output value and at least one of the plurality of second processing elements, through the second cumulative sum link, which is the row input link.

6. The method of claim 5, wherein the providing a second input frame to a second processing element disposed at a tail portion of the second processing element chain among the plurality of processing elements through a second input data link that is a row input link includes,
providing a second input frame to the second processing element disposed in the tail portion based on an (M+1) cycle,
wherein the M is a time required for one of the first processing elements to perform an operation based on the preloaded weight and the first output value, and
wherein the cycle is a difference between a time provided to the first processing element in which the first input frame is disposed in the tail portion and a time to obtain the first cumulative sum.

7. The method of claim 5, wherein, in the step of obtaining the second output value, at least one of the second processing elements does not perform the operation based on the second input frame and the preloaded weight value.

8. The method of claim 5, wherein, in the step of obtaining the second cumulative sum value, at least one of the second processing elements does not perform the operation based on the second output value and the preloaded weight value.
